(19) United States
(12) Patent Application Publication
(10) Pub. No.: US 2022/0371702 A1
(43) Pub. Date: Nov. 24, 2022

(54) PORTABLE MARINE CAMPING APPARATUS

(71) Applicants: Darryl Sand, Campbell River (CA); Andrew Noble, Campbell River (CA)

(72) Inventors: Darryl Sand, Campbell River (CA); Andrew Noble, Campbell River (CA)

(21) Appl. No.: 17/323,687

(22) Filed: May 18, 2021

(51) Int. Cl. B63B 35/38; B63B 1/12; B63B 3/48; B63B 7/08; H02S 10/12; H02S 10/40

(52) U.S. Cl. CPC B63B 35/38; B63B 1/12; B63B 3/48; B63B 7/082; B63B 7/085; H02S 10/12; H02S 10/40; B63H 21/12

(57) ABSTRACT

A portable marine camping apparatus that is configured to provide a camping and recreational platform that can navigate waterways wherein the present invention is inflatable so as to facilitate easy transport thereof. The present invention includes a deck assembly that is superposed a hull portion wherein the deck assembly is planar in manner and includes rigid high pressure air chambers. Integrally formed with the deck assembly is a tent module wherein the tent module is manufactured from inflatable components and is deployed during inflation of the deck assembly. A boat unit is operably coupled to the rear of the deck assembly and is configured to provide propulsion of the portable marine camping apparatus 100. A fire module is formed with the deck assembly and is manufactured from steel grate panels. The fire assembly further includes a receptacle for receiving combustible materials.

### FIELD OF THE INVENTION

The present invention relates generally to outdoor equipment, more specifically but not by way of limitation, a portable apparatus that is designed to facilitate navigation of waterways such as but not limited to small lakes wherein the present invention further includes elements such as but not limited to a tent so as to provide an integrated vessel and camping apparatus.

### BACKGROUND

Recreational outdoor activities are extremely popular around the world. Millions of people every year participate in outdoor activities such as but not limited to camping, hiking and fishing. To participate in most outdoor activities will typically require an investment in apparatus such as but not limited to camping equipment and boating equipment. For those individuals who live in areas where lakes are accessible it is common to both purchase a small boat as well as purchase a variety of camping gear. Camping gear is typically portable and includes items such as but not limited to tents, chairs and other items needed to make a campground. These items can be bulky and are often required to be transported to the site. If a terrestrial accessible campsite is chosen these items can be transported via vehicles such as but not limited to all-terrain vehicles.

One challenge for boaters that wish to also camp is the logistics of transporting all of the items needed to both navigate a waterway as well as set up a campsite. This can involve a great deal of equipment and can be quite expensive as it involves the purchase of a marine vessel as well as all of the necessary camping equipment such as but not limited to a tent. Conventional apparatus and methods often require the use of a truck to tow the boat and haul all of the camping gear.

Accordingly, there is a need for a portable marine camping apparatus that is both a marine vessel and further includes an integrated camping site having all of the necessary equipment such as but not limited to a tent and wherein in the present invention the apparatus is inflatable so as to accommodate improved storage and transportation thereof.

### SUMMARY OF THE INVENTION

It is the object of the present invention to provide a portable marine camping apparatus that includes an inflatable marine vessel operably coupled thereto wherein the present invention includes a deck assembly wherein the deck assembly is inflatable.

Another object of the present invention is to provide an integrated marine vessel and camping platform that is configured to provide a waterway navigable apparatus suitable for fishing and camping wherein the deck assembly includes a hull portion wherein the hull portion are inflatable pontoons integrally formed with the deck assembly.

A further object of the present invention is to provide a portable marine camping apparatus that includes an inflatable marine vessel operably coupled thereto wherein the deck assembly of the present invention includes a tent module wherein the tent module is integrally formed with the deck assembly and is inflatable in a preferred embodiment.

Still another object of the present invention is to provide an integrated marine vessel and camping platform that is configured to provide a waterway navigable apparatus suitable for fishing and camping wherein the deck assembly of the present invention includes a fire module wherein the fire module of the present invention is operably coupled to the deck assembly and is manufactured from a material such as but not limited to steel grate panels.

An additional object of the present invention is to provide a portable marine camping apparatus that includes an inflatable marine vessel operably coupled thereto wherein the present invention further includes an integrated compressor that is operable to inflate the deck assembly, tent module and other inflatable elements of the present invention.

Yet a further object of the present invention is to provide an integrated marine vessel and camping platform that is configured to provide a waterway navigable apparatus suitable for fishing and camping wherein the deck assembly further includes integrated ice chest assemblies configured to receive ice and food items therein.

Another object of the present invention is to provide a portable marine camping apparatus that includes an inflatable marine vessel operably coupled thereto wherein the present invention further includes a power generation module wherein the power generation module is configured to convert both sun and wind into electrical power needed to operate the portable marine camping apparatus.

Still an additional object of the present invention is to provide an integrated marine vessel and camping platform that is configured to provide a waterway navigable apparatus suitable for fishing and camping wherein the present invention further includes elements such as but not limited to fishing accessories such as down rigger mounts and rod holders integrally formed in the deck assembly.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is top view of an exemplary embodiment of the present invention; and

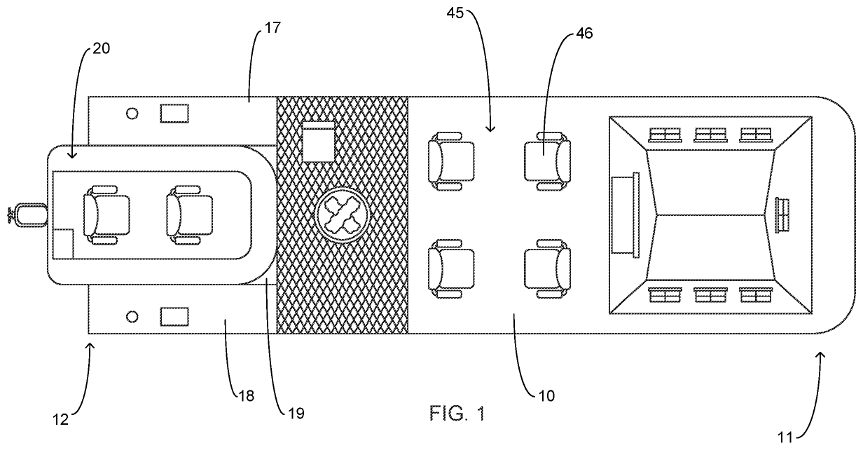

FIG. 2 is a front perspective view of an exemplary embodiment of the present invention.

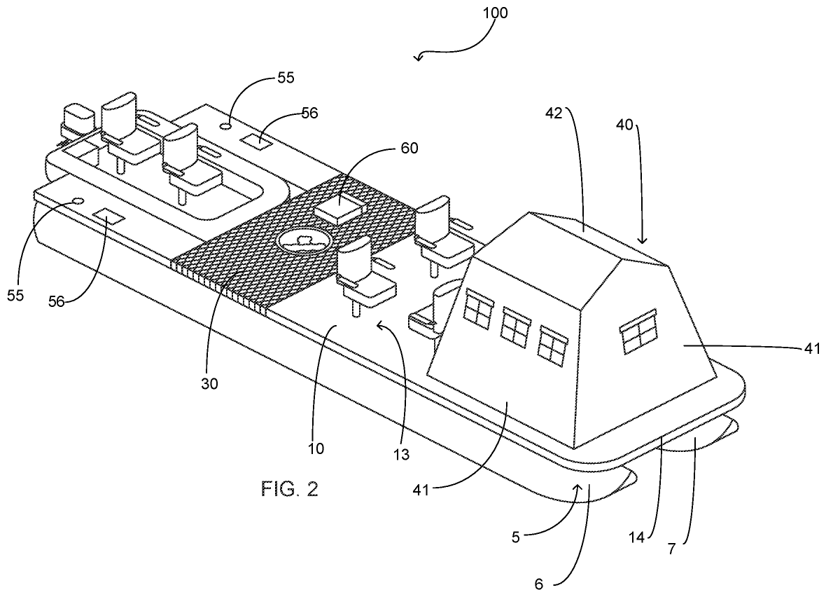

### DETAILED DESCRIPTION

Referring now to the drawings submitted herewith, wherein various elements depicted therein are not necessarily drawn to scale and wherein through the views and figures like elements are referenced with identical reference numerals, there is illustrated a portable marine camping apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the portable marine camping apparatus 100 includes a deck assembly 10. The deck assembly 10 is planar in manner and is generally rectangular in shape. The deck assembly 10 includes a first end 11 and second end 12 and further includes upper surface 13 and outer perimeter edge 14. The deck assembly 10 as with many of the elements of the portable marine camping apparatus 100 discussed herein is manufactured from an inflatable material such as but not limited to hypalon. The deck assembly 10 includes a plurality of high pressure air chambers(not particularly illustrated herein) wherein the high pressure air chambers provide a rigid surface for a user to stand thereon. Additionally, the high pressure air chambers of the deck assembly 10 provide a suitable support structure for elements such as but not limited to the tent module 40. The deck assembly 10 is manufactured from a plurality of high pressure air chambers in order to facilitate the deflating and transportation of the portable marine camping apparatus 100. It should be understood within the scope of the present invention that the deck assembly 10 could be manufactured in alternate sizes and shapes and still achieve the desired function described herein. It is further contemplated within the scope of the present invention that the outer perimeter edge 14 could be manufactured from a material such as but not limited to metal in order to assist in providing a desired structural rigidity and further allow for operable coupled of additional modules as is further discussed herein.

Secured to the deck assembly 10 is the hull portion 5. The hull portion 5 is comprised of a first pontoon 6 and a second pontoon 7 wherein the first pontoon 6 and second pontoon 7 are located on opposing sides of the deck assembly 10 and also extend the entire length thereof. The hull portion 5 is configured to assist in the floating and navigation of the portable marine camping apparatus 100. In a preferred embodiment of the present invention the hull portion 5 is manufactured from the same material as the deck assembly 10 and is integrally formed therewith in order to be inflated at the same time. It is desired within the scope of the present invention that the first pontoon 6 and second pontoon 7 are comprised of a plurality of high pressure chambers that are isolated with valves in order to ensure flotation in the event of a loss air pressure within one or more chambers.

The second end 12 of the deck assembly 10 includes a first portion 17 and a second portion 18 that are opposedly located having a void 19 therebetween. The aforementioned structure of the present invention is operable to facilitate the mateable coupling of the deck assembly 10 with a boat unit 20. The boat unit 20 is a conventional boat such as but not limited to an inflatable boat wherein the boat unit 20 is operably coupled within the void 19 so as to provide propulsion to the portable marine camping apparatus 100. The boat unit 20 can employ either a combustible or electric motor and it is contemplated within the scope of the present invention that the boat unit 20 could be provided in alternate sizes. Furthermore, it should be understood within the scope of the present invention that the boat unit 20 is releasably secured to the deck assembly 10 utilizing suitable durable techniques such as but not limited to ropes. While a boat unit 20 is illustrated and discussed herein, it should be understood within the scope of the present invention that the portable marine camping apparatus 100 could have a motor operably secured thereto for propulsion of the portable marine camping apparatus 100 wherein no boat unit 20 would be required.

Secured to the deck assembly 10 is the fire module 30. The fire module 30 is configured to be level with the upper surface 13 of the deck assembly 10 and is manufactured from a non-combustible material such as but not limited to steel grate panels. The fire module 30 can be suspendedly mounted to the outer perimeter edge 14 ensuing inflation of the deck assembly 10. The fire module 30 includes receptacle 32 that is configured to have combustible materials disposed therein for burning thereof. The fire module 30 extends across the full width of the deck assembly 10 and has a sufficient length so as to allow general fire debris such as but not limited to sparks to avoid contact with the deck assembly 10. The steel grate panels of the fire module 30 allow for embers to pass therethrough and fall into the water which will inhibit fire risk to the portable marine camping apparatus 100. It should be understood within the scope of the present invention that the receptacle 32 could be manufactured in alternate sizes and shapes.

Integrally formed with the deck assembly 10 proximate the first end 11 is the tent module 40. The tent module 40 includes a plurality of walls 41 and a roof 42 wherein the tent module 40 is constructed to provide shelter for those utilizing the portable marine camping apparatus 100. The tent module 40 is manufactured from the same inflatable material as the deck assembly 10 and includes high pressure air chambers that allow for the formation of rigid walls 41 and roof 42 during inflation of the portable marine camping apparatus 100. The tent module 40 includes an interior volume(not illustrated herein) that is suitable in size to accommodate several individuals and items such as but not limited to sleeping bags and/or cots. It should be understood within the scope of the present invention that the tent module 40 could be provided in alternate shapes and sizes.

Located aft of the tent module 40 is sitting area 45. Sitting area 45 is an area of the upper surface 13 of the deck assembly 10 that is configured to receive or have integrally formed therewith sitting elements such as but not limited to chairs 46. The sitting area 45 provides the ability for a user to superpose thereon a plurality of alternate styles of chairs or other sitting devices. It should be understood within the scope of the present invention that the sitting area 45 could have inflatable integrally formed chairs or other sitting elements formed as a part thereof. Alternatively, it is contemplated within the scope of the present invention that the sitting area 45 is configured to receive a variety of chairs and/or tables superposed thereon.

The portable marine camping apparatus 100 further includes integrated fishing elements such as downrigger mounts 55 and ice chests 56. The downrigger mounts are conventional downrigger mounts that are integrally formed with the deck assembly 10 and configured to be operably coupled to a fishing downrigger. The ice chests 56 are formed within the deck assembly 10 and have an interior volume configured to receive ice and food items therein. It should be understood within the scope of the present invention that the portable marine camping apparatus 100 could have as a part thereof any quantity of ice chests 56 and downrigger mounts 55. Furthermore, it should be understood within the scope of the present invention that the ice chests 56 and downrigger mounts 55 could be located in alternate positions.

While not particularly illustrated herein, it is contemplated within the scope of the present invention that the portable marine camping apparatus 100 includes a twelve volt electrical system. The twelve volt electrical system could be independent or operably coupled to the boat unit 20. It is to be understood within the scope of the present invention that the electrical system could provide necessary power for elements such as but not limited to navigation lights and lighting within the tent module 40. It should be further understood within the scope of the present invention that the portable marine camping apparatus 100 could include either a solar charging panel and/or a wind charging unit that is operably coupled to the electrical system so as to provide charging for the batteries thereof.

The portable marine camping apparatus 100 further includes an air compressor 60. The air compressor 60 is a conventional air compressor that is operable to generate a high air pressure output. The air compressor 60 is pneumatically coupled to all of the inflatable elements of the present invention such as but not limited to the hull portion 5, deck assembly 10 and tent module 40. The air compressor 60 is configured to provide initial inflation of the portable marine camping apparatus 100 as well as maintain the required air pressure during use of the portable marine camping apparatus 100. It is further contemplated within the scope of the present invention that the air compressor 60 could be configured to facilitate the deflation of the portable marine camping apparatus 100 subsequent use thereof.

Additionally, while not illustrated herein, it should be understood within the scope of the present invention that the portable marine camping apparatus 100 will employ an anchoring system to facilitate the positioning of the portable marine camping apparatus 100 in a desired water location. As is known in the art, numerous styles of anchors and deployment elements such as but not limited to winches could be incorporated so as to comprise a desired anchoring system for the portable marine camping apparatus 100.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A portable marine camping apparatus that is configured to provide a recreational platform that can be navigated on waterways wherein the portable marine camping apparatus comprises:
a hull portion, said hull portion having a first pontoon and a second pontoon, said first pontoon and said second pontoon being on opposing sides of the portable marine camping apparatus, said first pontoon and said second pontoon being inflatable;
a deck assembly, said deck assembly being planar in manner and superposed said hull portion, said deck assembly having a first end and a second end, said deck assembly having an upper surface, said deck assembly extending a length equivalent to that of the hull portion, said deck assembly being inflatable;
a tent module, said tent module being integrally formed with said deck assembly, said tent module being pneumatically coupled to said deck assembly, said tent module being inflatable, said tent module being proximate said first end of said deck assembly; and
a fire module, said first module being located intermediate said first end and said second end of said deck assembly, said first module being manufactured from a non-combustible material, said fire module being configured to receive combustible materials thereon and have ignited to form a fire.

2. The portable marine camping apparatus as recited in claim 1, wherein said second end of said deck assembly includes a first portion and a second portion, said first portion of said second end of said deck assembly and said second portion of said second end of said deck assembly being located on opposing sides of said deck assembly.

3. The portable marine camping apparatus as recited in claim 2, wherein said first portion of said second end of said deck assembly and said second portion of said second end of said deck assembly include a void therebetween.

4. The portable marine camping apparatus as recited in claim 3, and further including a boat unit, said boat unit configured to be operably coupled within said void intermediate said first portion of said second end of said deck assembly and said second portion of said second end of said deck assembly.

5. The portable marine camping apparatus as recited in claim 4, wherein said fire module further includes a receptacle, said receptacle having an interior volume configured to receive and retain therein combustible materials.

6. The portable marine camping apparatus as recited in claim 5, wherein said deck assembly further includes at least one integrally formed ice chest.

7. The portable marine camping apparatus as recited in claim 6, and further including a compressor, said compressor being pneumatically coupled to said hull portion, said deck assembly and said tent module so as to facilitate inflation thereof.

8. A portable marine recreational apparatus that is configured to provide a suitable platform for camping and other recreational activities wherein the portable marine recreational apparatus is configured to navigate waterways and the apparatus of the present invention comprises:
a hull portion, said hull portion having a first pontoon and a second pontoon, said first pontoon and said second pontoon being on opposing sides of the portable marine camping apparatus, said first pontoon and said second pontoon being inflatable, said hull portion being substantially a length equal to that of the portable marine recreational apparatus;
a deck assembly, said deck assembly being planar in manner and superposed said hull portion, said deck assembly having a first end and a second end, said deck assembly having an outer perimeter edge, said deck assembly having an upper surface, said deck assembly being rectangular in shape, said deck assembly being inflatable, said deck assembly including a first portion and a second portion, said first portion of said second end of said deck assembly and said second portion of said second end of said deck assembly being located on opposing sides of said deck assembly;
a tent module, said tent module being integrally formed with said deck assembly, said tent module being pneumatically coupled to said deck assembly, said tent module having a plurality of walls and a roof, said tent module being inflatable, said tent module being proximate said first end of said deck assembly;
a fire module, said first module being located intermediate said first end and said second end of said deck assembly, said first module being manufactured from steel grate panels, said fire module being suspendedly mounted across the hull portion, said fire module having a width equal to that of the deck assembly, said fire module further having a receptacle, said receptacle being centrally located on said fire module, said receptacle having an interior volume configured to receive combustible materials therein; and
wherein the portable marine recreation apparatus is configured to be propelled on waterways to a desired location.

9. The portable marine recreational apparatus as recited in claim 8, wherein said first portion of said second end of said deck assembly and said second portion of said second end of said deck assembly include a void therebetween.

10. The portable marine recreational apparatus as recited in claim 9, and further including a compressor, said compressor configured to inflate the portable marine recreational apparatus wherein the hull portion, the tent module and the deck assembly are pneumatically coupled to said compressor.

11. The portable marine recreational apparatus as recited in claim 10, and further including a boat unit, said boat unit configured to be operably coupled within said void intermediate said first portion of said second end of said deck assembly and said second portion of said second end of said deck assembly, said boat unit releasably secured within said void, said boat unit operable to propel the portable marine recreational apparatus.

12. The portable marine recreational apparatus as recited in claim 11, wherein said deck assembly further includes at least one integrally formed ice chest.

13. The portable marine recreational apparatus as recited in claim 12, wherein said deck assembly includes a plurality of downrigger mounts.

14. The portable marine recreational apparatus as recited in claim 13, and further including a power generation module, wherein the power generation module utilizes photovoltaic cells and wind to generate electrical power for the portable marine recreational apparatus.
